(19) United States
(12) Patent Application Publication
(10) Pub. No.: US 2016/0231845 A1
(43) Pub. Date: Aug. 11, 2016

(54) ELECTRONIC APPARATUS AND GUIDE COVER

(71) Applicant: KYOCERA Document Solutions Inc., Osaka (JP)

(72) Inventor: Satoru Hayama, Osaka (JP)

(21) Appl. No.: 15/008,171

(22) Filed: Jan. 27, 2016

(30) Foreign Application Priority Data
Feb. 6, 2015 (JP) 2015-021880

(51) Int. Cl. G06F 3/041; G06F 1/18; G06F 3/044

(52) U.S. Cl. CPC G06F 3/0412; G06F 3/044; G06F 1/181

(57) ABSTRACT

An electronic apparatus includes a display device; a touch panel of an electrostatic capacitive type on a screen of the display device; and a guide cover capable of being attached to the touch panel and detached from the touch panel. The guide cover includes a non-conductive substrate member having a thickness that a touch is not detected by the touch panel on the basis of variation of electrostatic capacity due to the touch; a protrusion part on a top surface of the substrate member; and a conductive member inside of the substrate member corresponding to the protrusion part on the top surface.

### CROSS-REFERENCE TO RELATED APPLICATIONS

This application relates to and claims priority rights from Japanese Patent Application No. 2015-021880, filed on Feb. 6, 2015, the entire disclosures of which are hereby incorporated by reference herein.

### BACKGROUND

1. Field of the Present Disclosure

The present disclosure relates to an electronic apparatus and a guide cover.

2. Description of the Related Art

Recently, in an electronic apparatus, a touch panel is arranged on a display device such as a crystal liquid display, and used as an input device. On the basis of arranging a touch panel on a display device, an image of an operation unit such as soft key is displayed by the display device, and a user operation to the image of the operation unit is detected by the touch panel.

In an existent technique, when a touch-panel-type input device is equipped with a flat-plate-type guide plate that includes a guide hole, the guide hole is arranged at a position of a key displayed in the touch-panel-type input device. It aims at reducing misoperations to an adjacent key.

Recently, touch panels of multi-touch detection type are widely used. As methods for multi-touch detection, an electrostatic capacitive type and a resistive film type are mainly used. The electrostatic capacitive type detects variation of electrostatic capacity due to an approach of a fingertip. The resistive film type detects voltage when pressing two piled sheets of transparent electrodes.

In the aforementioned technique, the flat-plate-type guide plate is simply arranged on the touch panel, and therefore, if the touch panel is of an electrostatic capacitive type, then even though the guide plate is arranged, the misoperation arises due to detecting variation of the electrostatic capacity.

### SUMMARY

An electronic apparatus according to an aspect of the present disclosure includes a display device; a touch panel of an electrostatic capacitive type on a screen of the display device; and a guide cover capable of being attached to the touch panel and detached from the touch panel. The guide cover includes a non-conductive substrate member having a thickness that a touch is not detected by the touch panel on the basis of variation of electrostatic capacity due to the touch; a protrusion part on a top surface of the substrate member; and a conductive member inside of the substrate member corresponding to the protrusion part on the top surface.

A guide cover according to an aspect of the present disclosure is capable of being attached to a touch panel and detached from the touch panel on a screen of a display device; and includes a non-conductive substrate member having a thickness that a touch is not detected by the touch panel on the basis of variation of electrostatic capacity due to the touch; a protrusion part on a top surface of the substrate member; and a conductive member inside of the substrate member corresponding to the protrusion part on the top surface.

These and other objects, features and advantages of the present disclosure will become more apparent upon reading of the following detailed description along with the accompanied drawings.

### BRIEF DESCRIPTION OF THE DRAWINGS

FIG. 1 shows a top view that indicates a guide cover in an electronic apparatus according to Embodiment 1 of the present disclosure;

FIG. 2 shows a cross sectional view of the guide cover shown in FIG. 1;

FIG. 3 shows a top view that indicates an operation panel in the electronic apparatus according to Embodiment 1 of the present disclosure;

FIG. 4 shows a diagram that indicates a relation between a position of a protrusion part 21 of a guide cover 1 and a position of a soft key 121 displayed on a display device 111 in the electronic apparatus according to Embodiment 1;

FIG. 5 shows a top view that indicates a guide cover in an electronic apparatus according to Embodiment 2 of the present disclosure;

FIG. 6 shows a cross sectional view of the guide cover shown in FIG. 5; and

FIG. 7 shows a top view that indicates a guide cover in an electronic apparatus according to Embodiment 3 of the present disclosure.

### DETAILED DESCRIPTION

Hereinafter, embodiments according to an aspect of the present disclosure will be explained with reference to drawings.

Embodiment 1.

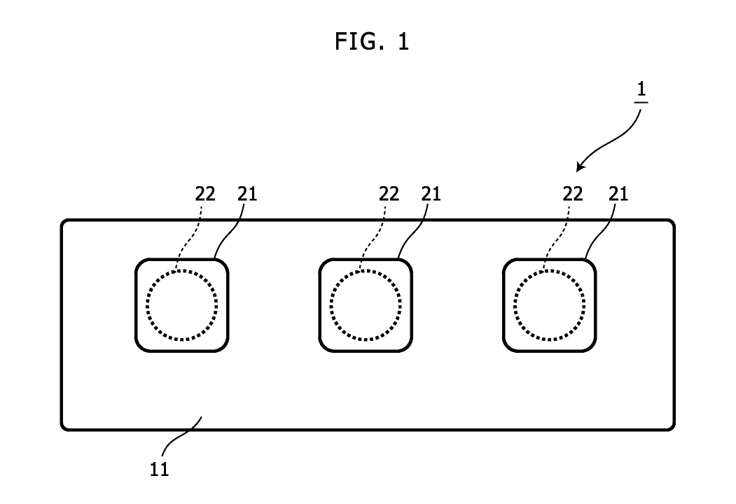

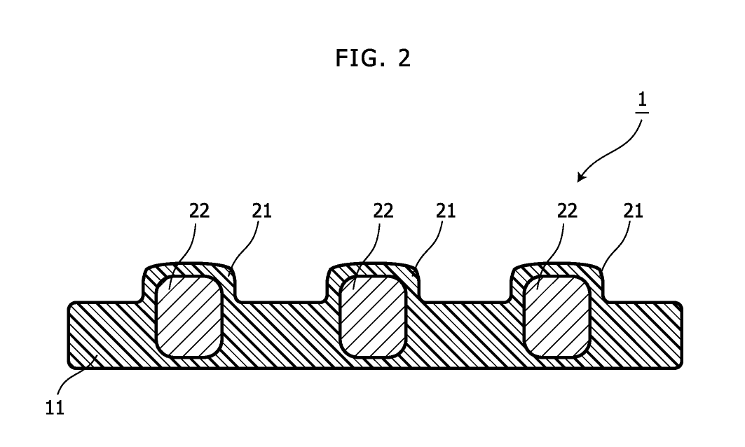

FIG. 1 shows a top view that indicates a guide cover in an electronic apparatus according to Embodiment 1 of the present disclosure. FIG. 2 shows a cross sectional view of the guide cover shown in FIG. 1. This electronic apparatus is, for example, an electronic apparatus equipped with a touch panel, such as an image forming apparatus.

The guide cover 1 shown in FIGS. 1 and 2 is capable of being attached to and detached from a touch panel on a screen of a display device in the electronic apparatus according to Embodiment 1.

The guide cover 1 includes a substrate member 11. The substrate member 11 is formed of non-conductive material such as silicone rubber and has a thickness that a touch of a finger or the like onto a top surface of the substrate member 11 is not detected by the touch panel in contact with a bottom surface of the substrate member 11 on the basis of variation of electrostatic capacity due to the touch. In addition, here, the substrate member 11 is formed of transparent material or translucent material.

The substrate member 11 has one or more protrusion parts 21 on a top surface thereof.

Further, a conductive member 22 is inside of the substrate member 11 corresponding to the protrusion part 21 on the top surface of the substrate member 11. The conductive member 22 has a columnar shape. Here, the conductive member 22 is a metal member. The conductive member 22 may be a resin member that was kneaded with conductive material such as metal or carbon.

The size of the conductive member 22 is designed so that the touch panel can detect variation of electrostatic capacity due to a touch of a finger or the like onto the corresponding protrusion part 21.

Specifically, a distance from a bottom surface of the substrate member 11 to a bottom surface of the conductive member 22 and a distance from a top surface of the substrate member 11 (i.e. a top surface of the corresponding protrusion part 21) to a top surface of the conductive member 22 are specified so that the touch panel can detect variation of electrostatic capacity due to a touch of a finger or the like onto the corresponding protrusion part 21.

Therefore, a sum of a distance from a bottom surface of the substrate member 11 to a bottom surface of the conductive member 22 and a distance from a top surface of the substrate member 11 (i.e. a top surface of the corresponding protrusion part 21) to a top surface of the conductive member 22 is smaller than a thickness of the other part of the substrate member 11 than the one or more protrusion parts 21.

The bottom surface of the conductive member 22 may be exposed from the bottom surface of the substrate member 11. The top surface of the conductive member 22 may be exposed from the top surface of the substrate member 11 (i.e. the top surface of the corresponding protrusion part 21).

Further, the conductive member 22 is arranged inside of the substrate member 11 so as to locate the top surface of the conductive member 22 at a height position higher than the other part than the one or more protrusion parts 21 of the top surface of the substrate member 11.

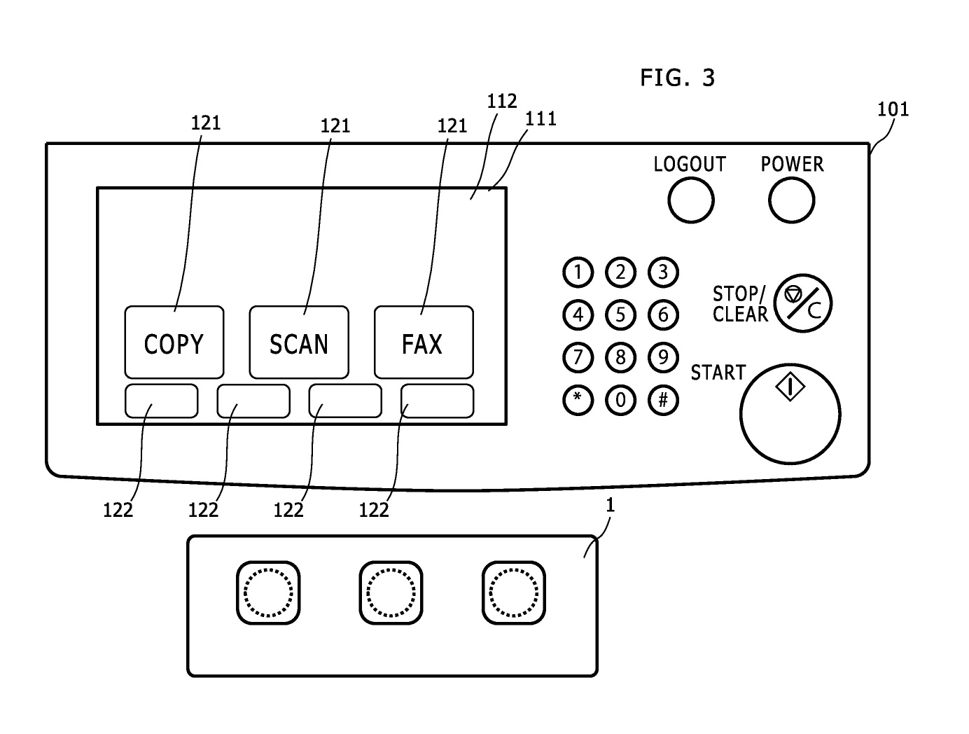

FIG. 3 shows a top view that indicates an operation panel in the electronic apparatus according to Embodiment 1 of the present disclosure.

The operation panel 101 shown in FIG. 3 is, for example, an operation panel of an image forming apparatus such as a multi function peripheral.

The operation panel 101 includes a display device 111 and a touch panel 112.

The display device 111 is, for example, a liquid crystal display, and the touch panel 112 is a touch panel of an electrostatic capacitive type that has been arranged on a screen of the display device 111.

The guide cover 1 has a width or a depth as same as a width or a depth of the display device 111 and the touch panel 112. Here, the guide cover 1 has a width as same as a width of the display device 111 and the touch panel 112. Therefore, the guide cover 1 is attached to the touch panel 112 so as to bring at least three sides of the substantially-rectangular guide cover 1 into contact with a frame surrounding the substantially-rectangular display device 111 and the substantially-rectangular touch panel 112. Consequently, the protrusion part 21 is arranged at a predetermined position on the screen.

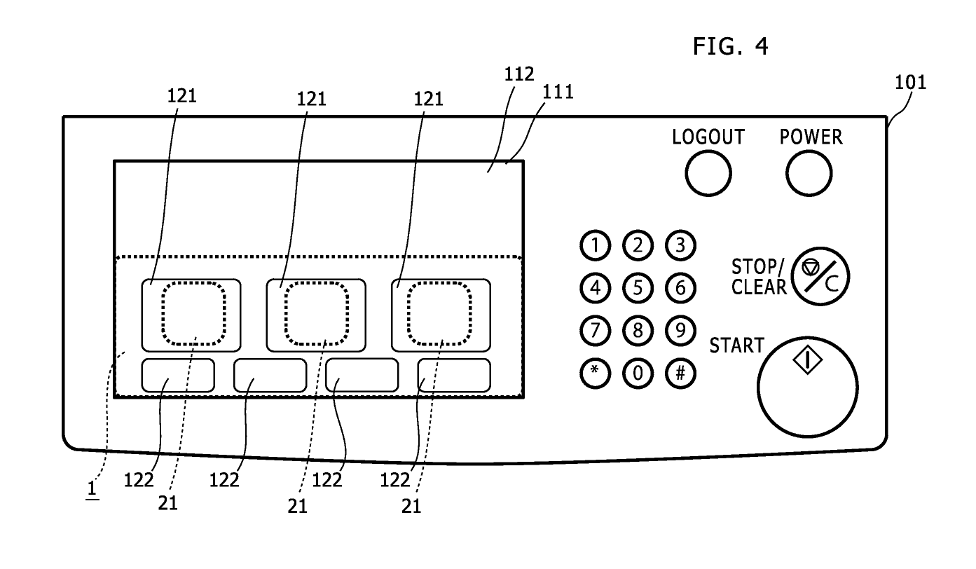

Further the electronic apparatus according to Embodiment 1 includes a controller that displays soft keys 121 and 122 on the display device 111. FIG. 4 shows a diagram that indicates a relation between a position of the protrusion part 21 of the guide cover 1 and a position of the soft key 121 displayed on the display device 111 in the electronic apparatus according to Embodiment 1. As shown in FIG. 4, when the guide cover 1 is attached to the touch panel 112, the controller displays the soft key 121 at a position where the corresponding protrusion part 21 is arranged, and displays the soft key 122 at a position covered by a part where no protrusion parts 21 are arranged.

The following part explains a behavior of the electronic apparatus according to Embodiment 1.

For example, as shown in FIGS. 3 and 4, the guide cover 1 is attached onto the touch panel 112 of the electronic apparatus and a soft key 121 is displayed on the display device 111 such as shown in FIG. 3.

In this situation, if a user touches the protrusion part 21 of the guide cover 1 with his/her finger, then the electrostatic capacity of the touch panel 112 is significantly varied because the conductive member 22 intervenes. Consequently the variation of the electrostatic capacity due to this touch is detected by the touch panel 112. Therefore, in this case, pressing the soft key 121 is detected.

Contrarily, even if a user touches another part of the substrate member 11 than the one or more protrusion parts 21 of the guide cover 1 with his/her finger, then the electrostatic capacity of the touch panel 112 is not substantially varied because the conductive member 22 does not intervene. Consequently the variation of the electrostatic capacity due to this touch is not detected by the touch panel 112. Therefore, in this case, pressing the soft key 121 is not detected.

In particular, even if a user touches a position where the soft key 122 is displayed in another part than the protrusion part 21 of a top surface of the substrate member 11 of the guide cover 1, the variation of the electrostatic capacity due to this touch is not detected by the touch panel 112, and therefore pressing the soft key 122 is not detected because no conductive members 22 are arranged so as to correspond to the soft key 122. Therefore, the guide cover 1 masks a soft key unnecessary for a user (e.g. visually impaired person) using this guide cover 1 to operate. Specifically, even if a user touches a position of the soft key 122 by mistake, the touch panel 112 does not detect the variation of the electrostatic capacity and consequently misoperation does not arise.

In the aforementioned Embodiment 1, the guide cover 1 includes (a) the non-conductive substrate member 11 having a thickness that a touch is not detected by the touch panel 112 on the basis of variation of electrostatic capacity due to the touch, (b) the protrusion part 21 on a top surface of the substrate member 11, and the conductive member 22 inside of the substrate member 11 corresponding to the protrusion part 21 on the top surface.

Therefore, the protrusion part 21 guides a user's finger to the soft key 121 and the guide cover 1 prevents the user from pressing another soft key than the soft key 121 displayed at a horizontal position of the protrusion part 21 and the conductive member 22, and consequently reduces misoperation to the electrostatic-capacitive-type touch panel 112.

Embodiment 2.

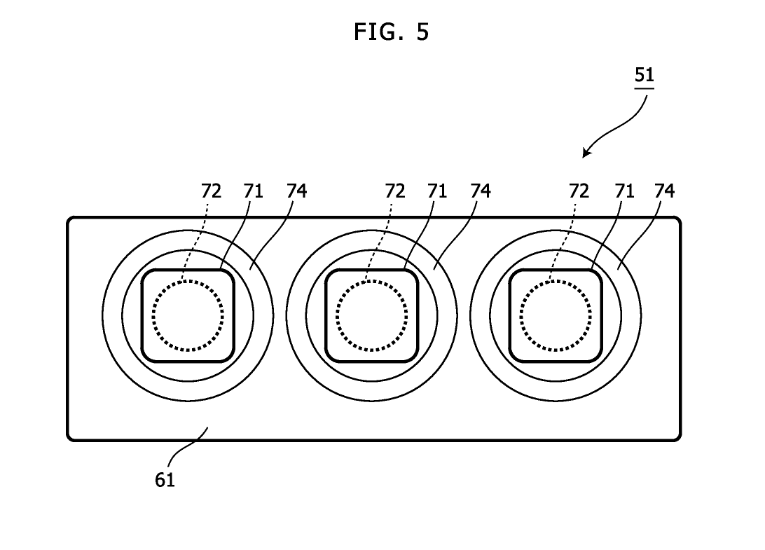

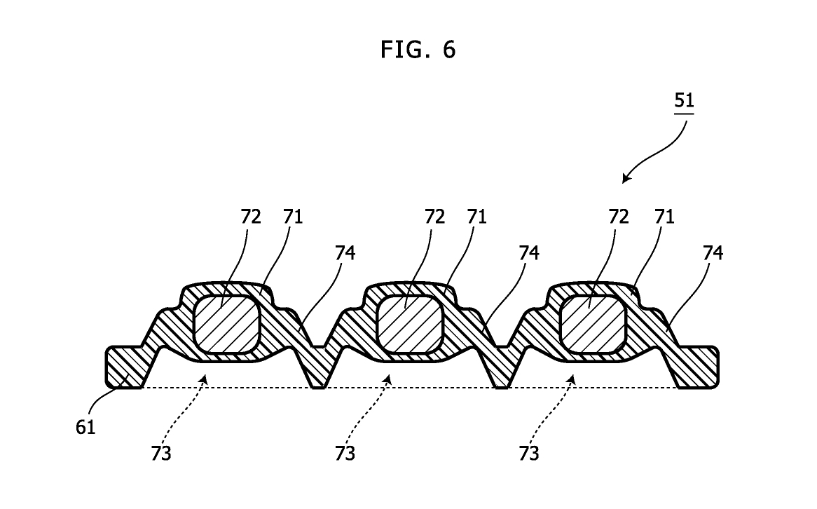

FIG. 5 shows a top view that indicates a guide cover in an electronic apparatus according to Embodiment 2 of the present disclosure. FIG. 6 shows a cross sectional view of the guide cover shown in FIG. 5.

As shown in FIGS. 5 and 6, the guide cover 51 in Embodiment 2 includes a substrate member 61, one or more protrusion parts 71 and one or more conductive members 72 as well as the substrate member 11, the one or more protrusion parts 21 and the one or more conductive members 22 of Embodiment 1, respectively.

Further in Embodiment 2, the guide cover 51 includes (a) a recess part 73 on a bottom surface of the substrate member 61 corresponding to the protrusion part 71 on the top surface of the substrate member 61, and (b) an elastic supporting part 74 having a ring and taper shape around the recess part 73. The elastic supporting part 74 is a part of the substrate member 61 and has a shape of (a) a ring parallel to the bottom and top surfaces of the substrate member 61 and (b) a taper with a ring diameter that appears larger at a height position closer to the bottom surface.

Thus, the elastic supporting part 74 causes the protrusion part 71 to have a rubber dome structure. Therefore, if a user touches and presses down the protrusion part 71, then the elastic supporting part 74 is elastically deformed, the protrusion part 71 and the conductive member are given force toward the bottom surface of the substrate member 61, i.e. the touch panel 112, and the bottom surface (i.e. the end side of the recess part 73 corresponding to the conductive member 72) of the substrate member 61 comes into contact with the touch panel 112. Consequently, when a user touches and presses down the protrusion part 71, then click feeling is provided to the user.

In a status that a user touches but does not press down the protrusion part 71, in order to prevent the touch panel 112 from detecting this touch on the basis of the variation of the electrostatic capacity, the bottom surface of the conductive member 72 is spaced from the bottom surface of the substrate member 61 in the height direction.

When the bottom surface (i.e. the end side of the recess part 73) of the substrate member 61 comes close to or into contact with the touch panel 112, the electrostatic capacity of the touch panel 112 is significantly varied because the conductive member 72 intervenes as well as Embodiment 1. Consequently this variation of the electrostatic capacity is detected by the touch panel 112. Therefore, in this case, pressing the soft key 121 is detected.

Contrarily, even if a user touches another part of the substrate member 61 than the one or more protrusion parts 71 of the guide cover 51 with his/her finger, then the electrostatic capacity of the touch panel 112 is not substantially varied because the conductive member 72 does not intervene. Consequently this variation of the electrostatic capacity is not detected by the touch panel 112. Therefore, in this case, pressing the soft keys 121 and 122 is not detected.

In the aforementioned Embodiment 2, the guide cover 51 includes (a) the recess part 73 on a bottom surface of the substrate member 61 corresponding to the protrusion part 71 on the top surface of the substrate member 61, and (b) the elastic supporting part 74 having a ring and taper shape around the recess part 73.

Therefore, when pressing down, click feeling is provided to the user with reducing misoperation to an electrostatic-capacitive-type touch panel.

Embodiment 3.

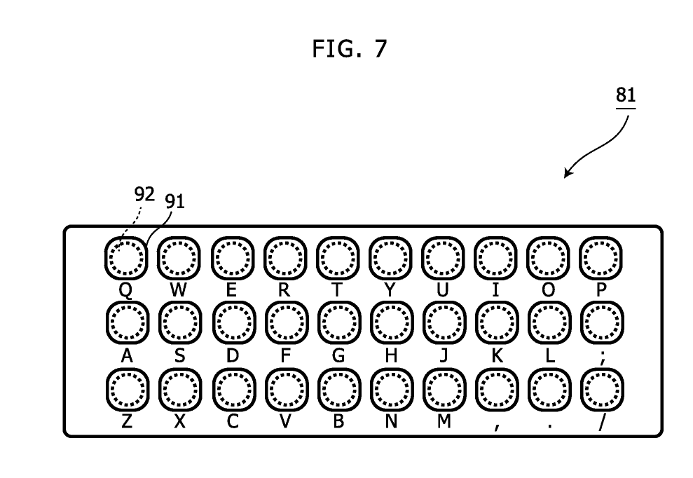

FIG. 7 shows a top view that indicates a guide cover in an electronic apparatus according to Embodiment 3 of the present disclosure.

In the guide cover 81 in Embodiment 3, as shown in FIG. 7, the electronic apparatus such as a smart phone or an image forming apparatus displays a software keyboard (QWERT keyboard) at a predetermined position on a screen, and protrusion parts 91 and conductive members 92 are arranged at positions corresponding to keys in the QWERT key layout of the software keyboard. It should be noted that a recess part and an elastic supporting part may be formed as well as Embodiment 2 for each set of the protrusion parts 91 and the conductive members 92.

The description has been presented for purposes of illustration and description, and is not intended to be exhaustive or limited.

For example, in the aforementioned Embodiment 1 or 2, on the top surface of the substrate member 11 or 61, explanation in Braille of a soft key corresponding to each protrusion part 21 or 71 may be formed and displayed so as to associate the explanation in Braille with the protrusion part 21 or 71.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An electronic apparatus, comprising:
a display device;
a touch panel of an electrostatic capacitive type on a screen of the display device; and
a guide cover capable of being attached to the touch panel and detached from the touch panel;
wherein the guide cover comprises:
a non-conductive substrate member having a thickness that a touch is not detected by the touch panel on the basis of variation of electrostatic capacity due to the touch;
a protrusion part on a top surface of the substrate member; and
a conductive member inside of the substrate member corresponding to the protrusion part on the top surface.

2. The electronic apparatus according to claim 1, wherein the guide cover further comprises:
a recess part on a bottom surface of the substrate member corresponding to the protrusion part on the top surface; and
an elastic supporting part having a ring and taper shape around the recess part.

3. The electronic apparatus according to claim 1, wherein the guide cover has a width or a depth as same as a width or a depth of the display device and the touch panel.

4. The electronic apparatus according to claim 1, further comprising a controller that displays a soft key on the display device;
wherein the controller displays the soft key at a position where the protrusion part is arranged when the guide cover is attached to the touch panel.

5. A guide cover capable of being attached to a touch panel and detached from the touch panel on a screen of a display device, comprising:
a non-conductive substrate member having a thickness that a touch is not detected by the touch panel on the basis of variation of electrostatic capacity due to the touch;
a protrusion part on a top surface of the substrate member; and
a conductive member inside of the substrate member corresponding to the protrusion part on the top surface.

6. The guide cover according to claim 5, further comprising:
a recess part on a bottom surface of the substrate member corresponding to the protrusion part on the top surface; and
an elastic supporting part having a ring and taper shape around the recess part.
